(19) United States
(12) Patent Application Publication
(10) Pub. No.: US 2007/0165107 A1
(43) Pub. Date: Jul. 19, 2007

(54) Visual positioning system for closed circuit video magnification system

(76) Inventor: James A. Trulaske, St. Louis, MO (US)

Correspondence Address: Paul M. Denk, Suite 170, 763 S. New Ballas Road, St. Louis, MO, 63141, US

(21) Appl. No.: 11/653,820

(22) Filed: Jan. 15, 2007

Related U.S. Application Data
(60) Provisional application No. 60/760,172, filed on Jan. 18, 2006.

(51) Int. Cl. H04N 15/00

(52) U.S. Cl. 348/42; 348/63

(57) ABSTRACT

A visual positioning system integrated into a magnification device for use for amplifying the size of materials being scanned, can be manipulated to furnish greater length dimension to the material scanned, by shifting and pivoting of either its miniaturized television camera, or the reflecting mirror that scans the camera pickup downwardly onto the textual material being reviewed. The mirror may be pivoted by various structures including a thumb wheel, that cams the mirror into different angular relationships relative to its associated camera, in order to enhance the length of the materials being reviewed and projected onto the television monitor.

### CROSS REFERENCE TO RELATED APPLICATION

This non-provisional application claims priority to the provisional application having Ser. No. 60/760,172 filed on Jan. 18, 2006, and to the non-provisional application having Ser. No. 11/359,800 filed on Feb. 22, 2006 which claims priority to the provisional application having Ser. No. 60/659,980 filed on Mar. 9, 2005. The preceding applications are all commonly owned by the same inventor.

This application is related to U.S. Pat. No. 5,633,674 from the same inventor.

### FIELD OF INVENTION

This invention relates generally to scanning technology, and more specifically pertains to means to expand the dimensional imaging system of an amplification system used in conjunction with a miniature camera or television that provides enlarged viewing of any scanned sheet of text, design, or other materials, for the visually impaired individual.

### BACKGROUND OF THE INVENTION

Various types of scanning mechanisms for amplifying or magnifying the text of any writings, the designs of any drawings, or other materials that are capable of being reviewed and read, but to the disabled person are difficult in viewing, have involved scanning devices, like miniature cameras, of a television mode type, that can scan such text, and amplify it onto a television screen, to which it has been electrically connected. The use of miniature cameras to achieve such activity have been available in the art, and one such camera system is shown in an earlier patent to the inventor herein, U.S. Pat. No. 5,633,674.

Others have utilized scanning technology, of the camera type, to achieve related results, and these are all known in the arts.

The copending patent application provided herein provides a system, including an apparatus that is self-contained, and which incorporates a two-dimensional shiftable platform, upon which correspondence, a book, or other text or design materials can rest, and the platen upon which they rest is shiftable in lateral and depth dimensions, so as to allow a camera to focus thereabove and to scan the page, and project it onto an integrated screen, such as on a television monitor, to allow the impaired person to easily read these materials, through the usage of such a system.

Normally, as is available in the art, most of the scanning devices that incorporate some type of a platen, even one that is shiftable, that provides for the text material, or drawings, to be rested thereupon, usually provide sufficient dimensional shifting that allows for the reading of a sheet of approximately an eight-and-a-half inch by eleven inch page. But, in some jurisdictions, such as the United Kingdom, the scanning must be at least in the length dimension of the page, in the range of eleven inches, or more. Hence, the device of U.S. Pat. No. 5,633,674 requires modification for usage in those other jurisdictions, which require the ability to scan longer pages of material, to comply by law, and to make it feasible to utilize this invention, to read such larger materials.

### SUMMARY OF THE INVENTION

This invention contemplates a fully integrated system that incorporates a structure base, upon which a platen or platform is shiftably mounted, and which can be moved laterally, and depth-wise, to provide a fully manipulatable platen upon which text or other written materials may be located, to provide for their ease of scanning, and subsequent projection for immediate review and reading on a conveniently arranged screen.

The platen of the previous invention, as structured onto the base of this present magnification system, incorporates a series of manipulatable arms, that extend upwardly, and provides for mounting of a screen, forwardly of the platform and which screen furnishes a television or LCD type of display, for viewing of any scanned materials, that may be projected thereon, for further magnified sighting for the convenience of the user. But, some jurisdictions require that the length dimension of the materials being scanned may exceed eleven inches. Therefore, it is a requirement that text, designs, or other materials, perhaps up to thirteen or fourteen inches, must likewise be capable of scanning upon such a system. One of the problems, though, is a platen that shifts, where if the platen is to be shifted greater than eleven inches, the user of the device, likely with impaired vision, will normally keep the apparatus in close contact with their abdomen, to get a closer view of the screen for the device, so the platen itself cannot be shifted to any greater extent than that of the previous invention.

Hence, the concept of this current invention is to provide means for structurally allowing for shifting of the viewing area of the television camera, miniaturized as it is, so that the camera may pick up the additional inches, whether it be two, three, four, or five inches of additional length, without the platen being manipulated or shifted to any greater extent.

And, the subject matter of this invention is to provide a reflective surface, such as a mirror, that mounts in front of the camera, to a small distance, such that the camera picks up the material being scanned, through the reflective mirror. In cooperation with the shifting of the platen up to approximately eight inches, the reflective mirror is capable of being pivoted in order to pick up an approximate additional five inches of length scanning of the text or other materials being viewed, to furnish enhanced length-wise scan ability of the system, during its usage.

Essentially, the invention contemplates the use of a reflective mirror, that is mounted a short distance in front of the camera. The mirror may incorporate a pivot point, on either side, or along some area between the opposite edges of the mirror, so that it can be pivoted to some angulated degree, up to approximately ten to fifteen degrees and through this pivoting of the mirror, a greater length of the material being scanned can be detected, by the camera, and then transmitted to the television monitor, for viewing by the user. To achieve such pivoting of the mirror, any type of cam-type means, can be used to bias against a surface of the mirror, to change its angular positioning as pivotally mounted within the main body or camera housing of the system, and a simple thumb or finger manipulation of the turnable cam, to some degree, can furnish the angular relationship of the mirror, to degree to furnish a different reflective angle to the television camera, or the miniaturized camera, to pick up additional length of text or other material being scanned. The mirror may include a biasing means, such as a spring, that normally urges the mirror into its regular positioning, for normal scanning, but that when the dial is turned, forces the mirror into a different angular setting, to pick up that additional material being scanned.

It is just as likely, on the other hand, that the television camera itself could be slightly pivoted, in its setting within the camera housing, and perhaps pick up some additional length of the material being scanned in that manner, but regardless of which system is utilized, the concept is to lengthen the scanning area of either the miniaturized camera, or its reflective mirror, in order to provide for expanded viewing of the text material being scanned by the camera.

It is, therefore, the principal object of this invention to provide a scanning system for the visually impaired, which can pick up a greater distance or length of the material being scanned, without requiring further shifting of the platen upon which the scanned material rests, beyond the normal shiftable positioning of said platen during its routine usage.

Another object of this invention is to provide for greater length of scanning of text or other materials, simply by manipulating camera positioning of the invention during usage.

Still another object of this invention is to provide for means for differing the angulated positioning of a reflective mirror, that cooperates with a miniaturized camera, to furnish a greater length of televised material being scanned for viewing by the sight impaired.

Still another object of this invention is to provide structured means that can facilitate the pivoting of a reflective surface, or even the television camera, used in a scanning system for aiding viewing by the visually impaired.

Yet another object of this invention is to provide a scanning device that is user friendly, particularly to those who suffer from visual impairment, and need text materials to be magnified to assist reading or viewing of such materials.

Still another object of this invention to provide for an indicator light, that is projected in combination with the focusing of a miniaturized television camera, through a reflective surface, down onto the platen holding textual material to provide an indication to the user as to exactly where the camera is focusing, during its usage and application.

Yet another object of this invention is to provide for the use of that focusing light, as just explained, and how it can be shifted depth-wise, upon a platen, to provide for an indication to a visually impaired person, as to exactly what is going to be reviewed, and picked up by the camera, when the television console is turned on for magnified viewing.

Still another object of this invention is to provide a reflection of light within a particular spectrum, normally in the orange range, which is easily and more susceptible of viewing by one who is vision impaired.

These and other objects may become more apparent to those skilled in the art upon review of the summary of the invention as provided herein, and upon undertaking and study of the description of its preferred embodiment, in view of the drawings.

### BRIEF DESCRIPTION OF THE DRAWINGS

In referring to the drawings,

FIG. 1 provides a cross-sectional schematic view of the camera housing, and the reflective mirror, pivotally mounted therein, for use for allowing the camera to pick up and visually read any materials located upon the shiftable platen for this magnification system;

FIG. 2 is a sectional schematic view of this invention, when it is normally used, with the camera focusing directly downward onto the platen to pick up and read the text or other materials located at that position on the platen as arranged therebelow, which is identified as the neutral scanning position for this system during usage;

FIG. 3. is a sectionalized schematic view of this invention where its reflecting mirror has been tilted, a few degrees upwardly or clockwise, to provide for scanning upon the platen of any materials located in a back position, as can be seen from the scanning line and its light reflective beam during usage of this magnification system;

FIG. 4. provides a schematic section of this invention where the reflecting mirror has been tilted in an opposite direction or downwardly or counterclockwise, for a few degrees, to pick up additional scanning of text material by its miniaturized camera, along the line as shown for the reflective beam of the indicator light, in this instance at a forward position relative to the shiftable platen arranged thereunder;

FIG. 5. is an upward view of the frontal segment of the camera housing, showing the location of the pivotal reflective mirror, and the manually operable means used for angularly shifting the mirror for the various degrees;

FIG. 6. is a view of the camera related tab that connects with the thumb wheel for angularly tilting of the reflective mirror; and,

FIG. 7 is a side sectional view of an alternate embodiment of the invention for adjusting the angle of the camera to enlarge the image.

The same reference numerals refer to the same parts throughout the various figures.

### DESCRIPTION OF THE PREFERRED EMBODIMENT

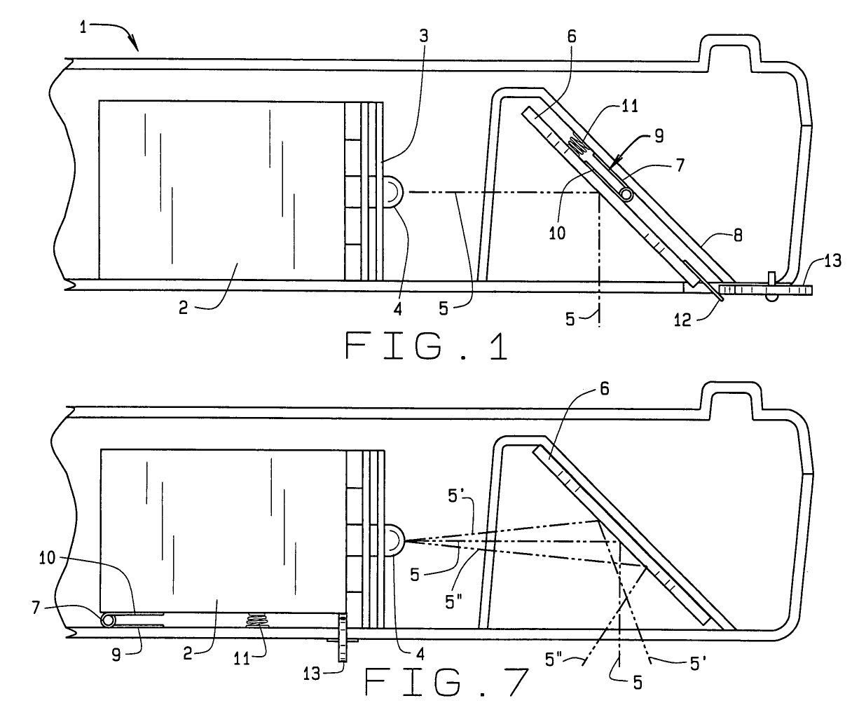

In referring to the drawings, and in particular FIG. 1, this is a schematic sectional view of the camera housing 1 of this invention. The miniaturized camera, identified as an auto focus camera, as at 2, has a frontal lens, generally in the vicinity of 3, scanning forwardly of the device, within its housing, and its beam of scan is generally along a horizontal line, corresponding to the line of reflection of the indicator light 4, generally as can be noted along the scan line 5. The reflecting mirror 6 of this invention, and as previously summarized, is held by means of a pivotal hinge 7 to the integral surface of the housing structure 8, at least along a leaf 9 of said hinge, while the opposite leaf 10 is cemented or otherwise secured to the back of the reflecting mirror 6, as can be understood. There is provided between the housing surface 8, and the back of the mirror 6, a biasing spring 11, which constantly urges the positioning of the mirror into its normal forty-five degree angulated position, as generally shown in FIG. 1. This provides for a ninety degree reflection of both the indicator light beam, as along 5, in addition to the scanning direction of the focused camera, as can be understood.

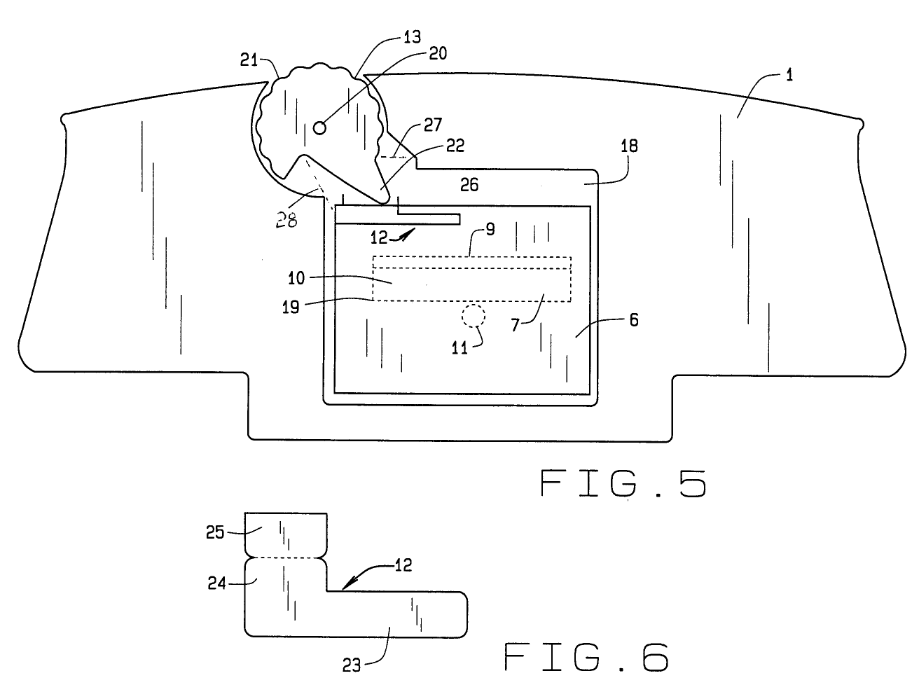

Provided at the lower end of the mirror 6 is a contact tab 12, which is adhesively or otherwise secured to the bottom back edge of the mirror 6, and this tab generally is of the type and configuration as shown in FIG. 6, as can be noted. Its particular configuration, and how it is assembled for usage, will be subsequently described.

Biasing against the tab 12, is a tilting device that alters the scan line of the camera, here shown as a camera thumb wheel 13, because it normally will be turned through urging by the thumb, or other finger, to provide for its acting against the tab, or where the tab may not be utilized, against the lower edge of the mirror, to shift it some angulated degrees, in a manner to be subsequently defined.

As can be seen in FIG. 1, the mirror is at its normal and standard position, which is usually at a forty-five degree angle with the horizontal, and in this manner, provides for a ninety degree reflection of the beam of the indicator light, and likewise the pickup by the miniaturized camera, in its focusing of any textual material that is arranged upon the platen therebelow.

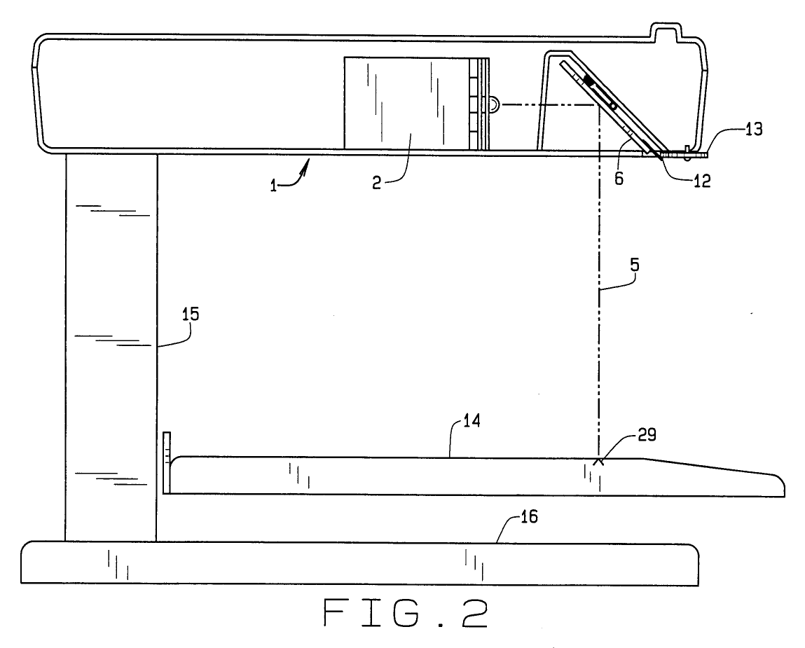

FIG. 2 shows the arrangement of the shiftable platen 14, provided at a lower segment within this visual positioning system, generally arranged parallel and below the camera housing 1, as previously reviewed. Thus, any text, design, or any other materials, to be reviewed, is rested upon the shiftable platen 14, as along its upper surface. Obviously, the platen being shiftable, as reviewed in a previous application, is shiftable width-wise, but more specifically depth-wise, in order to pick up the depth dimension of any material being scanned, at least up to approximately eight inches, through shifting of the platen, in the manner as previously reviewed. Furthermore, as can be seen in FIG. 2, the column 15 generally mounts the camera housing 1 upwardly from the platen, and the column is integrally secured with the base 16, to provide for an inherently structured mount, for the entire assembled magnification system, as it is assembled, and readied for usage. As can also be seen, the positioning of the camera, its reflecting indicator light, in addition to the reflecting mirror 6, are generally in the standard position 29 as previously described for this magnification system, as analyzed in FIG. 1.

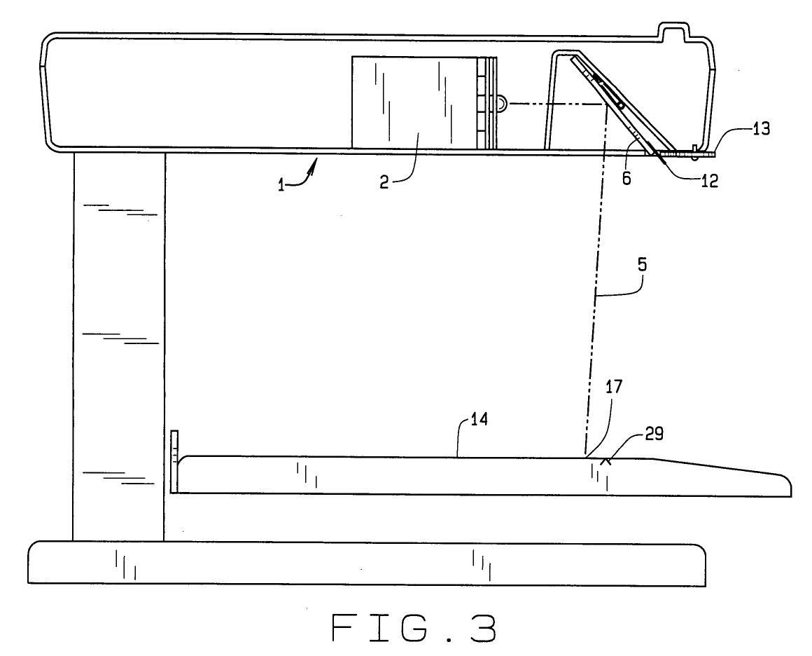

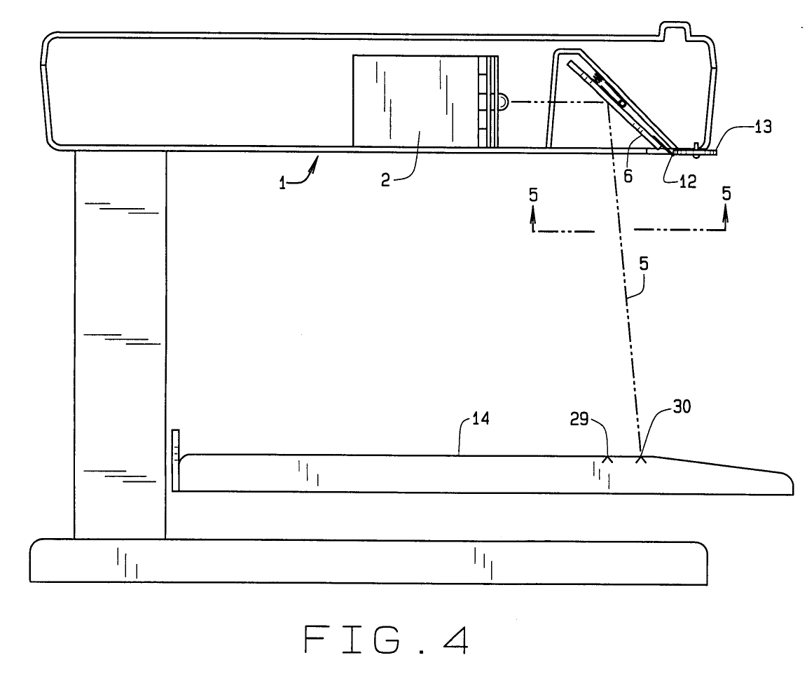

But, as can be seen in FIG. 3, where the length of the material being scanned may be greater than eight inches, the mirror 6 may be slightly pivoted, to the amount and degrees as previously reviewed, which may be in the range of ten to fifteen degrees, more or less, to the angulated position, in order to vary the scanning distance of the camera, in this particular instance, to a back position 17 as tab 12 is moved towards the column 15 or clockwise about the hinge. Hence, when the mirror is angulated further upwardly, as can be seen in FIG. 3, the line of reflection for the focusing of the camera is shifted to a back position, as generally noted at 17, and can pick up and detect text or other materials upon the page being displayed, at a greater height upon its surface. But, when the length of the material being scanned is greater than eight inches, as for example, should the material being scanned be in the range of twelve to thirteen inches, more or less, then the viewing area of the camera will be positioned at the eight inch mark, generally as explained with respect to the reference point 17 of FIG. 3, and upon further manipulating of the thumbwheel, as noted at 13, can vary the angulated position of the reflecting mirror 6, so as to pick up an additional approximately five inches of scanning, without shifting the textural material being scanned, in its setting upon the platen 14. Hence, since the normal shiftable area for the platen, as defined in my previous invention, is approximately eight inches in depth, when the mirror is pivoted in the manner as explained from FIG. 3, to an opposite angular relationship as disclosed in FIG. 4, an additional five inches, more or less, of text material may be scanned, simply through the manipulation of the thumb wheel 13, during usage of this device.

Additionally, the mirror 6 may be slightly pivoted in the opposite direction, to the amount and degrees as previously reviewed, ten to fifteen degrees, more or less, to the angulated position, to vary the scanning distance of the camera, in this particular instance, to a forward position 30 as tab 12 is moved away from the column 15 or counter-clockwise about the hinge. Hence, when the mirror is angulated further downwardly, as can be seen in FIG. 4, the line of reflection for the focusing of the camera is shifted to a forward position, as generally noted at 30, to detect text or other materials upon the page being displayed.

This description provides a preferred embodiment of the device and method for providing additional depth of scanning by this visual positioning system, without having to shift the text or material to any extent, once it has been rested upon the platen. This can be either text material, such as a book, a letter, or a sheet of paper, or it may comprise drawings, design sketches, or any other material that needs to be reviewed, and which may have a length beyond what is normally picked up by the usual visual positioning systems, as available in the art.

FIG. 5. provides a more detailed disclosure of the thumb wheel 13, that is used to achieve the slight pivot to the reflecting mirror 6, during its usage. The mirror is mounted within a well 18, integrally structured or molded within the camera housing 1, as previously reviewed. There is applied the pivotal hinge 7, as previously explained, its pivot mirror comprises a pair of hinge leaves 9 and 10, as also previously reviewed. The pivot point for the hinge is along the edge 19. The hinge is applied to the back side of the mirror, and to the surface of the structured housing well, in a manner as previously reviewed with respect to FIG. 1. The biasing spring 11 is also shown mounted to the surface of the housing well 18, in the manner as also shown in FIG. 1, and it biases against the back side of the reflecting mirror 6, as can be noted.

The means provided for pivotally angulating the mirror, to the minor degrees as explained, in one embodiment, is also shown in FIG. 5. This is that thumb wheel 13, as previously explained. It is pivotally mounted by means of its pivot pin or point 20 to the housing structure. It has a fluted edge, as can be noted in 21, along some segment of its surface, in order to facilitate its grasping by the thumb, or other finger, to achieve its forceful turning, when functioning to extend viewing by the camera unit. Extending generally outwardly from the thumb wheel 13 is a stem 22, which biases against the tab 12 to furnish a pushing there against, which likewise forces the mirror to slightly shift in its angular positioning, from that as shown in FIG. 3, to an opposite angle as shown in FIG. 4, both of these showing the extremes of pivot of the mirror, in order to attain that extra dimensional five additional inches of scanning ability for the camera, or the focusing of its indicator light, during usage of this system. The tab 12 as applied to the edge of the mirror, as previously referred to in FIG. 6, has a length segment 23, which is fastened, adhesively, or otherwise, proximate the edge of the mirror, and then its tab segments 24 and 25 are folded over, and adhered against each other, in order to add a little reinforcement, at the position where the stem 22 biases against the tab, in order to force the shifting of the mirror, between its two angulated limits, as previously reviewed.

As can also be seen in FIG. 5, the stem 22, and more particularly its biasing edge 26, can be shifted between the limits of its arc pivotal movement, from the position as noted at 27, which allows the mirror to pivot into the position as shown in FIG. 4, to an opposite angulated position, as at 28, which allows the mirror to undertake the angulated position as shown in FIG. 3, and through this manipulation of the thumb wheel, the mirror can shift between these two positions, and provide for enhanced pickup of the length or depth dimension of document being scanned, for an additional five inches, more or less.

An alternate embodiment of the present invention is shown in FIG. 7 where the camera repositions to alter the length of material captured from the platen. As before, the camera 2 is within a housing 1 generally located above a platen (not shown). The camera has a hinge 7 located towards the rear and has two leaves, 9, 10. Leaf 10 attaches to the camera and opens upwardly which tilts the camera upward and slightly towards the rear of the housing. Leaf 9 attaches to the housing and generally locates the pivoting of the hinge towards the rear of the housing. Inwardly from the hinge, the alternate embodiment has a spring 11 located beneath the camera 2 and upon the housing. The spring assists in tilting the camera with the least amount of effort by the user. Away from the spring and generally opposite the hinge, a thumbwheel 13 rotates about an axis parallel to the length of the housing. The thumbwheel, as in FIG. 5, has flutes 21 for grasping by a user's fingers and a stem 22 that abuts the camera for providing tilting thereto.

Opposite the hinge, the camera 2 has an indicator light 4 as before. In front of the camera and the indicator light, this alternate embodiment has a mirror 6 generally inclined at approximately 45 degrees to the horizon. The image gathered by the camera comes from the mirror and its view of the material below. With the camera also horizontal, the alternate embodiment provides a downward and centered view of material upon the platen as shown by the scan line 5. For expanding the scanning area, the user rotates the thumbwheel 13. Rotation in one direction elevates the front of the camera, tilting the indicator light 4 upwards. The upward tilt of the camera alters the scan line 5′ so that the scan provides more of the material, forward from the centered view of the material. Rotation of the thumbwheel in the opposite direction lowers the front of the camera, in this position, tilting the camera and the indicator light downwards. The downward tilt of the camera alters the scan line 5″ to provide more of the material but rearward from the centered view of the material.

This provides a generalized review of the structure of this visual positioning system, and how additional length positioning can be added to the style of magnification system, as explained in my previous application, in order to enhance the depth scanning of any document, to a longer length, in order to meet compliance with any codes, that may be required by particular jurisdictions, particularly in countries foreign to the United States, in order to allow this positioning system to be marketed worldwide, through the changes of structure and its functionality as reviewed and explained herein.

Variations or modifications to the subject matter of the invention may occur to those skilled in the art upon review of the development as disclosed herein. Such variations, if within the concept of this development, are intended to be encompassed within the scope of the invention as described. The specific details as set forth herein of the structure and functionality of this system, are set forth for illustrative purposes only.

I claim:

1. An image positioning system for displaying material for the visually impaired, said system mounting upon a column above a generally horizontal platen, said material placed upon said platen, comprising:
a camera,
a housing,
said camera locating within said housing and generally positioning parallel to said platen;
a mirror locating away from said camera, within said housing, and at an angle to the line of sight of said camera; and,
a tilting device allowing said camera to capture additional material upon the forward and back portions of said platen.

2. The image positioning system of claim 1 further comprising:
said tilting device having a thumbwheel with an edge;
said mirror having a tab engaging said edge of said thumbwheel; and,
said mirror pivoting about an axis perpendicular to the line of sight of said camera.

3. The image positioning system of claim 2 further comprising:
said mirror hingedly connecting to said housing; and,
a spring, locating between said mirror and said housing and generally biasing said mirror at a forty five degree angle to the horizontal.

4. The image positioning system of claim 3 further comprising:
said thumbwheel having fluting upon said edge and at least one stem extending radially from said edge; and,
said stem abutting said tab and rotating said mirror to collect additional length of image from said platen.

5. The image positioning system of claim 4 wherein said system collects at least an additional three inches of length of said material for viewing.

6. The image positioning system of claim 1 further comprising:
said tilting device having a thumbwheel with an edge; and,
said camera pivoting about an axis perpendicular to the line of sight of said camera, and said camera contacting said thumbwheel.

7. The image positioning system of claim 6 further comprising:
said camera hingedly connecting to said housing and a spring, locating between said camera and said housing and generally biasing said camera horizontal;
said tilting device having a thumbwheel engaging said camera from below, locating generally forward of said spring; and,
said mirror locating at a forty five degree angle to the horizontal and allowing for collection of an image from below said camera.

8. The image positioning system of claim 7 further comprising said thumbwheel having fluting upon said edge and at least one stem extending radially from said edge; and,
said stem abutting said camera and raising and lowering said camera to collect additional length of image from said platen.

9. The image positioning system of claim 8 wherein said system collects at least an additional three inches of length of said material for viewing.
